(19) United States
(12) Patent Application Publication
(10) Pub. No.: US 2006/0235623 A1
(43) Pub. Date: Oct. 19, 2006

(54) Method of processing biological analysis data and expert system of biological analysis applying this method

(76) Inventors: Patrick Rambaud, Montreal (CA); Lionel Chapy, Chanonat (FR)

Correspondence Address: YOUNG & THOMPSON, 745 SOUTH 23RD STREET, 2ND FLOOR, ARLINGTON, VA, 22202, US

(21) Appl. No.: 11/397,631

(22) Filed: Apr. 5, 2006

Related U.S. Application Data
(63) Continuation-in-part of application No. 10/111,900, filed on Sep. 25, 2002, now abandoned.

(30) Foreign Application Priority Data
Jan. 19, 2001 (FR) 01 00771

(51) Int. Cl. G06F 19/00

(52) U.S. Cl. 702/19; 702/20

(57) ABSTRACT

Expert system of biological analysis includes comprising: a collecting engine to collect and represent data resulting from biological measurements carried out on a human or animal subject and defining a biological profile, and personal data relating to the human or animal subject.

The present invention relates to an expert system of biological analysis.

In the field of biological analysis, there are already methods of determining the biological profile of a person from a set of measurements of characteristic physiological parameters. Starting from these biological profiles and data relating to the person concerned such as his age, his sex, his physical condition, the practitioner can then produce a set of conclusions or outputs leading to a diagnosis. A biological profile is comprised in practice of a set of specific profiles, such as a protein profile or lymphocyte typing.

The increase in the number of parameters involved in the determination of a biological profile makes it more and more difficult to establish consistent conclusions or outputs. In order to satisfy the expectations of practitioners who prescribe biological analyses, expert systems of biological analysis have been developed. These expert systems procure for users the processing of a set of items corresponding to biological measurements data and to personal data, and provide conclusions which can be used directly by the prescribing practitioner.

The methods of processing biological data that are used in these expert systems require a set of rules each applied to a determined combination of items among a global set of items corresponding to a set of measurements, examinations, dosages carried out on a patient or personal data. These rules lead to a set of conclusions which are drafted beforehand by one or more expert practitioners.

It has been shown in practice that the number of possible theoretical conclusions in an expert system of biological analysis, intended to integrate as complete as possible a biological profile in the current state of the techniques available in biological analysis, is so high that the feasibility of such an expert system and its implementation on conventional data-processing equipment other than large-capacity calculation and storage machines could be implicated.

Buchanon et al. (WO 00/42487) disclose a computer-implemented interactive expert system and method of using it for real time decision support in the medical field. The expert system disclosed in Buchanon et al. contains rules that can be created and modified. Pertinent subsets of rules can be selected to reduce response times by limiting the number of conclusions. However, selecting subsets of rules in order to limit the number of conclusions, may on the one hand be very time wasting and on the second affect the accuracy and rigour of the conclusions supplied to the user

The aim of the present invention is to propose an expert system of processing biological analysis data which on the one hand resolves effectively the question of the volume of data to be processed and consequently render such an expert system realisable, and which on the other hand procures for the practitioner using it a better relevance of the conclusions for interpretation of the analysis results.

This aim is achieved with an expert system of biological analysis, comprising:
a collecting engine to collect and represent, in the form of a set of groups of items, data resulting from biological measurements carried out on a human or animal subject and defining a biological profile, and personal data relating to the said human or animal subject,
a set of several groups of pre-established rules;
an inference engine to issue a set of conclusions by applying at least one group of the said set of groups of rules to:
   at least one group of items selected from the said set of groups of items; and/or
   at least one former set of conclusions issued by said inference engine,
      wherein it also comprises a gathering engine to minimize the number of conclusions in the said set of conclusions issued by the said inference engine.

Such gathering engine accomplishing gathering operations have the effect of making possible the implementation of an expert system of biological analysis on a personal office-based or portable data-processing apparatus, without affecting the accuracy and rigour of the conclusions supplied to the user.

It is to be noted that in the present invention gathering operations relates to gathering the number of conclusions in a set of conclusions and not to the fusion of chained rules as taught in the U.S. Pat. No. 5,442,792 which discloses a compiling method for an expert system.

It is also to be noted that an “engine” can be a computer program, one or more software run by a computer or made of computer executable instructions run by a computer, a processor or the like. Many structures of “engine” are well known in the expert systems known in the art, such as those described in the U.S. Pat. No. 5,263,126.

It is still to be noted that a “conclusion” means the output of a rule executed by an engine and more particularly by an inference engine. A “conclusion” can, for example, be a numerical value, a word, a sentence or the like, and is well known in the art.

Another aim of the method of data processing according to the invention is to permit the realisation of an expert system of biological analysis which integrates genetic profile data, knowledge of which is henceforth regarded as essential for the diagnosis and treatment of an increasing number of affections and pathologies.

This aim is achieved by an expert system comprising a genetic data collecting engine collecting data relating to the genetic profile of the said human or animal subject in the form of genetic items, said genetic data collecting engine also comprising a set of rules for the interpretation of the said genetic data.

The genetic data collecting engine can also comprise a processing of genetic data relating to this patient in the form of a set of genetic items associated with a set of genes studied in this patient, this processing comprising the application of rules of genetic interpretation applied at the same time to biological items and to genetic items.

With this expert system combining interpretation of a biological profile and interpretation of a genetic profile, it becomes possible to propose more accurate and more relevant conclusions due to the taking into account of affections linked with the genes.

It is to be noted that document WO 01/16860 discloses artificial intelligence system for a genetic analysis, which does not involve a gathering operation of a set of conclusions that have resulted from a group of rules, as proposed by the method according to the invention.

Said collecting engine, said set of several groups of pre-established rules, said inference engine and said gathering engine can also be integrated into an automated system including operations determining a biological and a genetic profile of a patient.

The expert system according to the present invention can further comprise a coupled knowledge base, so that it can reach all the information present in the knowledge base. Thus, with the expert system according to the present invention the interpretation of a biological profile and interpretation of a genetic profile, it becomes possible to propose more accurate and more relevant conclusions due to the taking into account of information present I the coupled knowledge base.

The biological profile taken into account in the expert system according to the present invention also includes a protein profile.

The biological profile taken into account in the expert system according to the present invention also includes a lymphocyte typing.

According to another aspect of the invention it is proposed an expert system of biological analysis, comprising computer executable instructions defining:
a collecting engine to collect and represent, in the form of a set of groups of items, data resulting from biological measurements carried out on a human or animal subject and defining a biological profile, and personal data relating to the said human or animal subject,
a set of several groups of pre-established rules;
an inference engine to issue a set of conclusions by applying at least one group of the said set of groups of rules to:
   at least one group of items selected from the said set of groups of items; and/or
   at least one former set of conclusions issued by said inference engine,
      wherein it also comprises a gathering engine to minimize the number of conclusions in the said set of conclusions issued by the said inference engine.

According to another aspect of the invention it is proposed a method for processing biological analysis data, comprising:
collecting and representing, in the form of a set of groups of items, data resulting from biological measurements carried out on a human or animal subject and defining a biological profile, and personal data relating to the said human or animal subject,
issuing a set of conclusions by applying at least one group of a set of several groups of pre-established rules to:
   at least one group of items selected from the said set of groups of items; and/or
   at least one former set of conclusions issued by said inference engine,
      wherein it also comprises gathering at least two conclusions from the said set of conclusions to minimize the number of conclusions in the said set of conclusions.

Other advantages and characteristics of the invention will appear upon examination of the detailed description of an embodiment, which is no way limitative, and of the attached drawings in which:

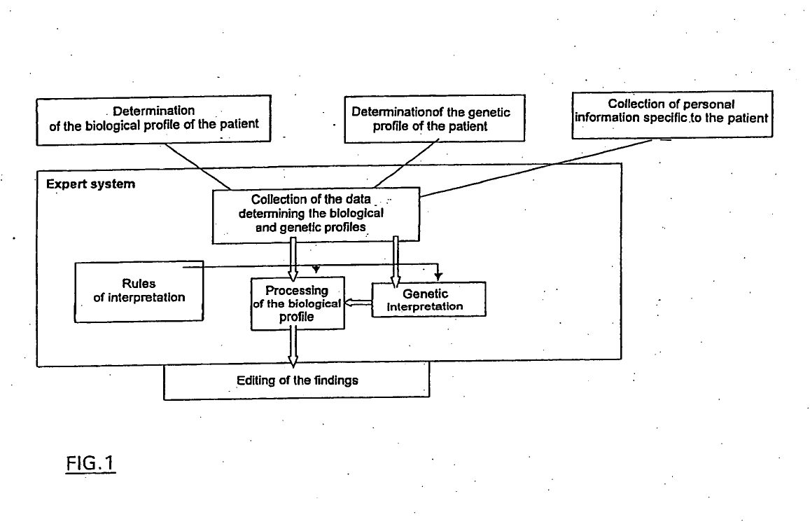

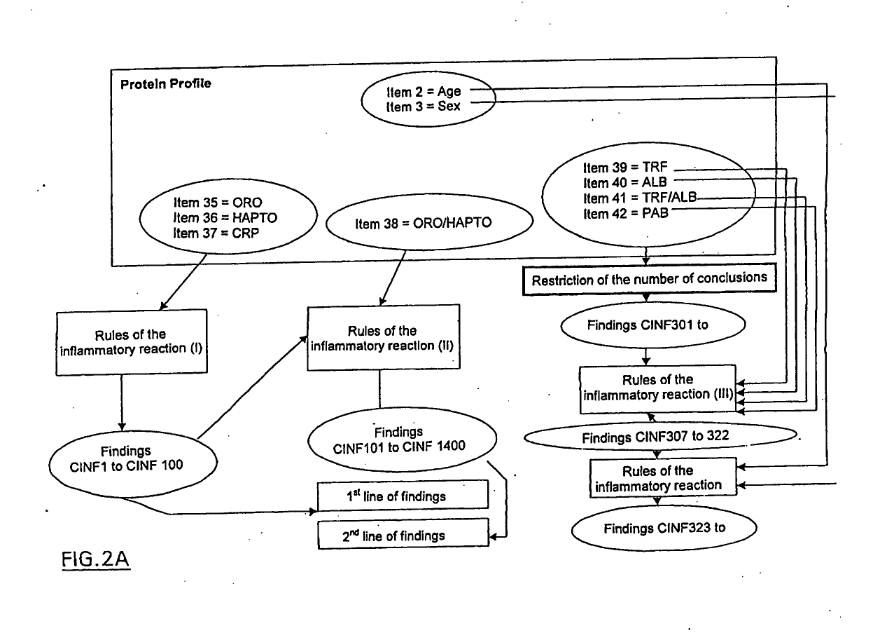

FIG. 1 is a functional diagram of an expert system of biological analysis according to the invention,

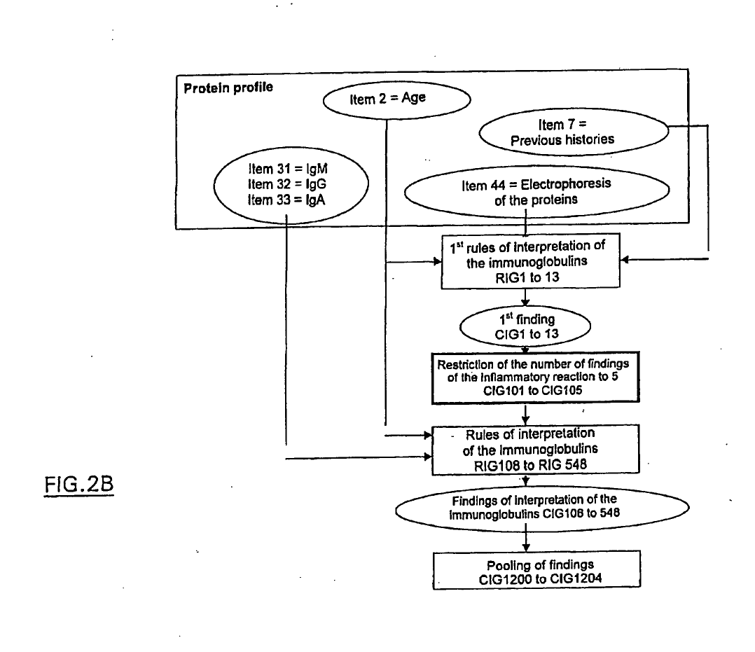

FIG. 2A illustrates an example of internal structure of the engine of an expert system according to the invention, relating more particularly to rules of the inflammatory reaction, and

FIG. 2B illustrates an example of internal structure of the engine of an expert system according to the invention, relating more particularly to rules of interpretation of immunoglobulin.

An expert system according to the invention of biological analysis according to the invention can in practice be implemented within a computer such as an office computer or a portable computer, and accessed locally or remotely. Its internal architecture, which can conform to current standards applying to expert systems, includes, with reference to FIG. 1, a module for collecting data determining profiles, respectively biological (protein in particular) and genetic profiles, of a patient, a module for collecting personal information specific to the patient, rules of interpretation applied to a processing of the biological profile realised with a genetic interpretation, and an editing of conclusions or outputs that can be used by a practitioner user.

The set of rules contained in this expert system according to the invention is organised into groups of rules each group corresponding to a group of specific analysis among several groups of analysis. For example, one may consider the group of rules of the inflammatory reaction or the group of rules interpreting immunoglobulins.

An embodiment of an expert system according to the invention will now be described, with reference to FIGS. 2A and 2B, being limited, for reasons of fullness of the description and clarity, only to the protein profile of a patient, it being understood that other specific biological profiles could be processed in an equivalent manner within the scope of the present invention.

In this expert system, a protein profile comprises optional items such as Item 43=ROP or Item 45=C4 and a set of obligatory items such as the following items:

Item 2 = Age
Item 3 = Sex
Item 35 = ORO
35.1 = Normal
35.2 = Increased
35.3 = Much increased
35.4 = Reduced
Item 36 = HAPTO
36.1 = Normal
36.2 = Increased
36.3 = Much increased
36.4 = Reduced
36.5 = Much reduced
36.6 = Hapto <10%
Item 37 = CRP
37.1 = Normal <33%
37.2 = Normal increased
37.3 = Increased
37.4 = Much increased
37.5 = Very much increased . . .
Item 39 = TRF
39.1 = Normal
39.2 = Increased (obligatorily >119,
not below)
39.3 = Reduced
Item 40 = ALB
40.1 = Normal or increased (>89%)
40.2 = Reduced (<89%)
Item 41 = TRF/ALB
41.1 = Normal
41.2 = Increased
Item 42 = PAB
42.1 = Normal or increased (>84%)
42.2 = Reduced (<84%)
Item 44 = Electrophoresis of
the proteins effected
NO
IgM
IgG
IgA
Monoclonal peak not M, not G, not A
Double monoclonal peak
Absence of monoclonal protein

The expert system according to the invention includes rules of the inflammatory reaction such as the following rules:
RINF1=35.1+36.1+37.1=CINF1
RINF2=35.1+36.1+37.2=CINF2
. . .
RINF100=35.4+36.5+37.5=CINF100

The conclusions associated with these rules of the inflammatory reaction are for example written up in the following way:
CINF1=No inflammatory reaction as the proteins of the inflammation (CRP, Alpha-1-glycoprotein or orosomucoid, haptoglobin) are normal.
CINF2=The proteins of the inflammatory reaction are all in normal values. However, the level of CRP, although normal, may suggest the presence of microinflammations (to be taken into consideration in the assessment of the cardiovascular risk after formal elimination of any other potentially phlogogenic spot).
. . .
CINF100=The results lean towards an inflammatory process based solely on the strong increase in the CRP. This may be the start of an inflammatory process since the CRP, a protein of acute inflammation, increases more quickly than the other proteins of the inflammation. Such an induction leans towards an infectious and/or inflammatory spot that is at the present time recent and very active, kept in an active state or in re-induction phase. The low level of haptoglobin is favourable for a hemolysis. Any haptoglobin result below 50% can be considered pathological. It may thus be of benefit to seek the cause of this hemolysis. Here, the reduced level of alpha-1-glycoprotein need not suggest a medicament treatment in the first place, but rather a protein leak, or a hepatocytic insufficiency.

A table of the normal values makes possible the linking with numerical values of the items ORO, HPT, CRP of results such as:

| | | | MUCH | | |
|---|---|---|---|---|---|
| | | IN- | IN- | RE- | MUCH |
| | NORMAL | CREASED | CREASED | DUCED | REDUCED |
| ORO | 70 to | 151 to 200% | >200% | <70% | — |
| | 149% | | | | |
| HPT | 60 to | 161 to 200% | >200% | 50 to 60% | <50% |
| | 160% | | | | |

| | N1 | N2 | N3 | N4 | N5 |
|---|---|---|---|---|---|
| CRP | 0 to | 67 to 200% | 201 to 666% | 667 to | >2000% |
| | 66% | | | 2000% | |

| | | | | |
|---|---|---|---|---|
| Reminder | 100% = 3 mg | = 6 to 20 mg | = 21 to 60 mg | >60 mg |

| | | | MUCH | | |
|---|---|---|---|---|---|
| | | IN- | IN- | RE- | MUCH |
| | NORMAL | CREASED | CREASED | DUCED | REDUCED |
| ORO/ | 0.75 to 1.5 | >1.5 | — | <0.75 | — |
| HPT | | | | | |

There will now be described new rules of the inflammatory reaction corresponding to an interpretation of item 38 in relation to the conclusions for the three items 35, 36, 37.
RINF101=CINF1+138.1 [symbol] CINF101
RINF102=CINF1+138.2 [symbol] CINF102
RINF103=CINF1+138.3 [symbol] CINF103
. . .
RINF116=CINF7+138.1 [symbol] (CINF116)=CINF101
. . .
RIN165=CINF31+138.2 [symbol] IMPOSSIBLE
. . .

The set of conclusions corresponding to these rules includes for example:
CINF101=No dissociation of the orosomucoid/haptoglobin pair which remains homogeneous.
CINF02=Dissociation between the alpha-1-glycoprotein and the haptoglobin. The dissociation leans towards a hemolysis. However, given the level of haptoglobin, the hemolysis is not necessarily to be regarded as pathological.
. . .
CINF107=CINF101
. . .
CINF1400=This reduction, with orosomucoid/haptoglobin dissociation, may result from a desialyting activity affecting the orosomucoid such as taking dibasic medicaments modifying the antigenic structure of the protein (antibiotics, AINS, beta-blockers, . . . ) or resulting from a slight loss of protein through leakage of urinary, digestive, cutaneous origin as orosomucoid, which is a protein of low molecular weight, is very sensitive to the pathologies of leakage.

The start of the protein profile thus presents itself as follows:
printing of the finding CINF1 to CINF100
printing of the finding CINF101 to CINF240

The conclusions CINF1 to CINF100 are then linked with items 39, 40, 41, 42. Although there are actually only 60 different conclusions, this would lead to far too great a number of rules. It is thus proposed to make changes in these 60 conclusions in order to end up with a more limited number of conclusions, for example 6, with reference to FIG. 2A.

If 6 conclusions CINF301 to CINF306 are considered, linked with items 39 (TRF), 40 (ALB), 41 (TRF/ALB), 42 (PAB), 6×3×2×2×2, i.e. 144 complementary rules must be provided.

But the high TRF must be interpreted as a function of sex and age. Now, out of 144 rules, a high TRF is observed 48 times. 48×2 (sex)×3 (age), i.e. 288 supplementary rules must therefore be provided. In addition, within the sex and age, there is the criterion of whether a woman is menopausal or not, which leads to 12×6, i.e. 72 complementary rules.

The total number of rules is thus 144+288+72, i.e. 504 rules. However, 96 rules actually prove to be impossible. There are thus 408 possible different rules.

The 6 resultant conclusions are:
1) CINF301: no, or very slight, inflammatory reaction
2) CINF302: inflammatory reaction based solely on the increase in CRP
3) CINF303: inflammatory reaction with increase in only one protein of the chronic reaction
4) CINF304: clear inflammatory reaction with normal CRP
5) CINF305: clear inflammatory reaction with increased CRP
6) CINF306: reduction in the proteins of the chronic inflammation

The 408 possible different rules include:
RINF307=CINF301+139.1+140.1+141.1+142.1=CINF307
. . .
RINF738=CINF306+139.3+140.2+141.2+142.2=CINF738

The interpretation of the Ig (immunoglobulins) in the protein profile will now be considered. The items concerned are I31 (IgM), I32 (IgG) and I33 (IgA). The interpretation is different depending on whether there is or not a monoclonal protein. Now, the presence of a monoclonal protein is not visible in the protein profile but in another analysis which is electrophoresis of the proteins.

Now, this electrophoresis is not always requested together with a profile. Moreover, if it is carried out, a monoclonal protein is found only rarely. When a monoclonal protein is found, the interpretation stops there, and this finding is not linked with an inflammatory reaction. Thus, the interpretation of the Ig starts with the processing of item 44 “Electrophoresis of the proteins”.

The reply may be:
yes with presence of a monoclonal protein (1^{st} finding),
yes with absence of monoclonal protein (new 1^{st} finding),
no (new 1^{st} finding).

Any individual can present Ig levels outside the standard values without this being pathological. What is pathological is the variation in this level of Ig over two taking, hence the processing of item 7 “previous histories”. If the reply is no, this means a 2^{nd} finding of a general order before the actual processing of the Ig.

Items 31, 32, 33 must then be linked with the inflammatory reaction. The conclusions of the interpretation of the immunoglobulins have been reduced to 5 according to a method similar to that adopted for the inflammatory reactions:
no inflammatory reaction
slight inflammatory reaction
inflammatory reaction due solely to CRP
inflammatory reaction present (1, 2 or 3 proteins)
reduction of the proteins of the inflammatory reaction.

The 3^{rd} finding will thus be chosen from among the following rules:
I31×I32×I33×C5
5×3×5×5=375 new rules.

The first finding can be established in the following way:
RIG1=144.2.1+12.1=CIG1
. . .
RIG13=17.2=CIG13
CIG1=The electrophoresis and the immunoelectrophoresis revealed a monoclonal IgM. Given the patient's age, one must think first of a sub-acute or chronic severe infection or viral or bacterial origin. This suggests an associated immunodeficiency.
. . .
CIG13=The values of the Ig reflect all of the defences acquired during life as a function of encounters with the different pathogens. At adult age, in a healthy person, this level does not vary much. It is thus perfectly possible that a level outside the normal values has no pathological connotation, but be a perfectly physiological level for the patient. What is interesting is the assessment of the variation over two samples several months apart. Not having any prior history for this patient, the different etiologies proposed enjoy only indicative status, as the interpretation must be carried out above all in relation to the clinical context

As indicated above, the 60 different conclusions of the inflammatory reaction are reduced to 5, so that the following conclusions are determined:

No Inflammatory Reaction

CINF1 or CINF2 or CINF3 or CINF17 or CINF21 or CINF22 or CINF23 or
CINF6 or CINF16 or CINF18 or CINF26 or CINF76 or CINF77 or CINF78=CIG101
   Slight Inflammatory Reaction
CINF7 or CINF8 or CINF31 . . . or CINF83=CIG102
   Inflammatory Reaction Due Solely to CRP
CINF4 or CINF5 or CINF19 . . . or CINF80=CIG103
   Inflammatory Reaction Present (Due to One or More Proteins)
CINF9 or CINF10 or . . . or CINF34 . . . or CINF90=CIG104
   Reduction in Proteins
CINF91 or CINF92 or CINF93 or CINF94 or CINF95 or CINF96 or CINF97 or CINF98 or CINF99 or CINF100=CIG105
The 375 rules for the 3^{rd} finding are then established, such as by way of example:
   RIG106=CIG101+131.1+132.1+133.1=CIG106
   . . .
   RIG548=CIG105+131.5+132.3+133.5=CIG548
   . . .

Complementary rules as a function of age are added to take account of the situations where each time there will be an inflammatory reaction (CIG104) without any increase in the Ig, or with a reduction in the IgM. In order to create these complementary rules, a gathering of certain of the CIGxxx conclusions mentioned above is carried out in order to end up with 5 conclusions CIG1200, CIG1201, CIG1202, CIG1203, CIG1204 which are used in the establishment of these complementary rules.

An embodiment of the method of processing data according to the invention will now be described, for a combined interpretation of the genetic profile and cardiovascular risk.

Firstly, a non-exhaustive list of genes that can be interpreted within the scope of the expert system of biological analysis according to the invention is provided in table I below. For each gene, a + symbol in a column indicates that this gene plays a part in the characteristic corresponding to this column, and conversely a − symbol in another column indicates that the same gene does not play a part in the characteristic corresponding to this other column. Thus, by way of example, the gene CYP1A1 plays a part in the case of smoker and as regards nutrigenetics, but not as regards pharmacogenetics, immunogenetics and for oxidative stress. Thus, each +symbol in this table corresponds to links and rules which must be written and integrated into the expert system.

There follow, by way of non-limitative example, extracts of biological interpretation supplied by an expert system according to the invention, regarding cardiovascular risk:
“in the light of the biological results, there is no atherogenic risk. The other risk factors must therefore be explored, as nearly 20% of patients who have cardiovascular problems present a normal or sub-normal biology.”
[. . .]
“Hyperhomocystinemia caused by congenital deficiency of the enzymes involved in its biosynthesis is much more rare. For example, cystathionine-beta-synthase deficiency is estimated at 1/20000 subjects who, in addition to cardiovascular risk, also have mental backwardness, and a dislocation of the crystalline lens, osseous deformations. On the other hand, 5-10 methylinetetrahydrofolate reductase deficiency is more frequent, being estimated at 5% of the general population, and is the major cause of genetic predisposition to moderate hyperhomocystinemia. These patients often present cardiovascular disorders in the first years of life [. . . ]”
This constitutes an indication for conducting genetic tests in order to know whether the increase in homocysteine is genetic in origin or not.
“Although the E2 allele seems to play a part in type III hyperlipoproteinemias, the E4 allele is also more involved in cardiovascular diseases. The E2/E4 genotype, although infrequent, thus substantially increases the risks of cardiovascular problems. Generally speaking, the average cholesterolemia of E4/E3 subjects is greater than that of E3/E3 subjects, which is itself greater than that of E3/E2 subjects. In the same way, the average concentration of LDL cholesterol in E4/E3 subjects is greater than that of E3/E3 subjects, which is itself greater than that of E2/E2 subjects. On the other hand, the triglycerides are significantly higher in E2/E2; E3/E2; E4/E2 subjects than in E3/E3; E4/E3 subjects.”
This finding reflects a direct relationship between interpretation of a genetic profile and interpretation of a biological profile (cholesterol, triglycerides). There is presented below an example of a finding reflecting a direct relationship between genetics and diet:
“Subjects carrying the E4 allele are more sensitive to hypolipemic and hypocholesterolemic diets. In the same subjects, the return to a diet rich in fats, in particular in saturated fatty acids, leads to a greater increase in plasmatic cholesterol.”
The expert system according to the invention can also take account, in the conclusions supplied to the user, of a direct relationship between the interpretation of the genetic profile and data relating to the medicament treatment that are obtained from personal information specific to the patient, as illustrated by the finding presented below:
“Subjects carrying the E2 allele and affected by hyperlipoproteinemia of lib type respond well to treatment by gemfibrozil and by statins (simvastatin and lovastatin). Among subjects affected by hyperlipoproteinemia of lia type, carriers of the E2 or E3 allele respond well to treatment by statins. Subjects carrying the E4 allele would on the other hand respond less well to hypolipidemic medicamentous treatments, with the exception, perhaps, of probucol.”

The invention is, of course, not limited to the examples which have just been described and numerous modifications can be made to these examples without exceeding the scope of the invention. In particular, provision can be made for complete automation of the operations for determining the biological profile and the genetic profile of a patient, and the combined treatment of these profiles. Moreover, it will easily be understood that an expert system of biological analysis according to the invention can also be coupled with databases and knowledge bases. In addition, within the framework of the present invention, the biological profile not only includes several families of determinations and biological analysis which are henceforth well established such as protein profiling or lymphocyte typing, but also other profiles in the process of being developed or which will be proposed in the future. In the same way, the expert system according to the invention is intended to take account of increasingly complex genetic profiles as scientific and technological advances occur in this field.

TABLE I

| | Predisposition | | | | | |
|---|---|---|---|---|---|---|
| | to | | | | | |
| Genes | disease | Pharmacogenetic | Immunogenetic | Smoker | Stress O. | Nutrigenetic |
| Phase I of | | | | | | |
| bio- | | | | | | |
| transformation | | | | | | |
| CYP1A1 | + | − | − | + | − | + |
| CYP1A2 | + | + | − | + | − | − |
| CYP2A6 | + | + | − | + | − | − |
| CYP3A4 | + | + | − | − | − | + |
| CYP2B6 | + | + | − | − | − | + |
| CYP1B1 | + | + | − | − | − | + |
| CYP2D6 | + | + | − | − | − | − |
| CYP2E1 | + | − | − | − | − | + |
| CYP2C19 | + | + | − | − | − | − |
| CYP2C9 | − | + | − | − | − | − |
| MEH | + | − | − | + | − | − |
| ALDH | + | − | − | + | − | − |
| ADH2 | + | − | − | + | − | − |
| Phase II of | | | | | | |
| bio- | | | | | | |
| transformation | | | | | | |
| GSTM1 | + | + | + | + | + | + |
| GSTM3 | + | − | − | − | + | + |
| GSTT1 | + | − | − | + | + | + |
| GSTP1 | + | + | − | − | + | + |
| NAT2 | + | + | + | + | − | + |
| NAT1 | + | + | + | + | − | + |
| Trigger | | | | | | |
| genes | | | | | | |
| Osteoporosis | | | | | | |
| Vit D3 | + | − | − | − | − | − |
| Col1A1 | + | − | − | − | − | − |
| ER | + | − | − | − | − | − |
| CTR | + | − | − | − | − | − |
| AIDS | | | | | | |
| CCR5 | + | − | − | − | − | − |
| SDF1 | + | − | − | − | − | − |
| CCR2 | + | − | − | − | − | − |
| CXCR4 | + | − | − | − | − | − |
| Breast | | | | | | |
| cancer | | | | | | |
| BRCA1 | + | − | − | − | − | − |
| BRCA2 | + | − | − | − | − | − |
| Prostate | | | | | | |
| cancer | | | | | | |
| AR | + | − | − | − | − | − |
| Hereditary | | | | | | |
| trombophilia | | | | | | |
| Factor V | + | − | − | − | − | − |
| Hemochromatosis | | | | | | |
| HFE | + | − | − | − | − | − |
| Bronchial | | | | | | |
| and allergic | | | | | | |
| asthma | | | | | | |
| CC16 | + | − | − | − | − | − |
| AAT-locus | + | − | − | + | − | − |
| HNMT | + | − | − | + | − | − |
| PAFAH | + | − | − | + | − | − |
| AACT | + | − | − | + | − | − |
| Primary | | | | | | |
| Hypercholesteremia | | | | | | |
| LDLR | + | − | − | − | − | − |
| APOB | + | − | − | − | − | − |
| Cardiovascular | | | | | | |
| risk | | | | | | |
| MTHFR | + | − | − | − | − | − |
| ACE | + | − | − | − | − | − |
| Efflux genes | | | | | | |
| MDR1 | − | + | − | − | − | − |
| MDR3 | − | + | − | − | − | − |
| LRP | − | + | − | − | − | − |
| MRP1 | − | + | − | − | − | − |
| Other | | | | | | |
| metabolizing | | | | | | |
| genes | | | | | | |
| NQO1 | + | − | − | − | + | − |
| Cytokine | | | | | | |
| genes | | | | | | |
| IL-1a | + | − | + | − | − | − |
| IL-1b | + | − | + | − | − | − |
| ILRN | + | − | + | − | − | − |
| IL-2 | + | − | + | − | − | − |
| IL-4 | + | − | + | − | − | − |
| IL-6 | + | − | + | − | − | − |
| IL-9 | + | − | + | − | − | −− |

1. Expert system for processing biological analysis data, comprising:
a collecting engine to collect and represent, in the form of a set of groups of items, data resulting from biological measurements carried out on a human or animal subject and defining a biological profile, and personal data relating to the said human or animal subject,
a set of several groups of pre-established rules;
an inference engine to issue a set of conclusions by applying at least one group of the said set of groups of rules to:
at least one group of items selected from the said set of groups of items; and/or
at least one former set of conclusions issued by said inference engine,
wherein it also comprises a gathering engine to minimize the number of conclusions in the said set of conclusions issued by the said inference engine.

2. Expert system according to claim 1, further comprising a genetic data collecting engine collecting data relating to the genetic profile of the said human or animal subject in the form of genetic items, said genetic data collecting engine also comprising a set of rules for the interpretation of the said genetic data.

3. Expert system according to claim 1, wherein said collecting engine, said set of several groups of pre-established rules, said inference engine and said gathering engine are integrated into an automated system including operations determining a biological and a genetic profile of a patient.

4. Expert system according to claim 1, further comprising a coupled knowledge base.

5. Expert system according to claim 1, wherein the biological profile includes a protein profile.

6. Expert system according to claim 1, wherein the biological profile includes a lymphocyte typing.

7. Expert system of biological analysis, comprising computer executable instructions defining:
a collecting engine to collect and represent, in the form of a set of groups of items, data resulting from biological measurements carried out on a human or animal subject and defining a biological profile, and personal data relating to the said human or animal subject,
a set of several groups of pre-established rules;
an inference engine to issue a set of conclusions by applying at least one group of the said set of groups of rules to:
at least one group of items selected from the said set of groups of items; and/or
at least one former set of conclusions issued by said inference engine,
wherein it also comprises a gathering engine to minimize the number of conclusions in the said set of conclusions issued by the said inference engine.

8. Method for processing biological analysis data, comprising:
collecting and representing, in the form of a set of groups of items, data resulting from biological measurements carried out on a human or animal subject and defining a biological profile, and personal data relating to the said human or animal subject,
issuing a set of conclusions by applying at least one group of a set of several groups of pre-established rules to:
at least one group of items selected from the said set of groups of items; and/or
at least one former set of conclusions issued by said inference engine,
wherein it also comprises gathering at least two conclusions from the said set of conclusions to minimize the number of conclusions in the said set of conclusions.
